(19) United States
(12) Patent Application Publication
(10) Pub. No.: US 2022/0152867 A1
(43) Pub. Date: May 19, 2022

(54) 3D PRINTING METHOD FOR PRODUCING CONCRETE-CONTAINING SEGMENTS OF A 3D OBJECT

(71) Applicant: BASF SE, Ludwigshafen am Rhein (DE)

(72) Inventors: Maik SCHACHT, Ludwigshafen (DE); Markus STREICHER, Ausburg (DE); Bogdan MORARU, Ausburg (DE)

(21) Appl. No.: 17/432,013

(22) PCT Filed: Feb. 7, 2020
(86) PCT No.: PCT/EP2020/053174

§ 371 Date: Aug. 18, 2021

(30) Foreign Application Priority Data
Feb. 19, 2019 (EP) 19158121.4

(51) Int. Cl. B28B 1/00; B33Y 10/00; B33Y 80/00

(52) U.S. Cl. CPC B28B 1/001; B33Y 80/00; B33Y 10/00

(57) ABSTRACT

The present invention relates to a three-dimensional (3D) printing process for the (layer-by-layer) production of at least one at least three-layer concrete-comprising segment (subregion) of a three-dimensional (3D) object based on concrete. In the process, a first concrete layer is firstly produced by extrusion of fresh concrete. Subsequently, a first adhesive layer is applied on top of the upward-facing side of the first concrete layer, after which a second concrete layer is applied to the upward-facing side of the first adhesive layer. Further adhesive and concrete layers can optionally be applied in succession, with the corresponding concrete layers and adhesive layers in the respective segment being arranged on top of one another in alternating order and the uppermost layer and the lowermost layer of the respective concrete-comprising segment being in each case formed by a concrete layer. The present invention further provides an at least three-layer concrete-comprising segment of a 3D object as such, which is produced by the process of the invention. The invention further provides for the use of at least one at least three-layer concrete-comprising segment as such for producing a 3D object or for incorporation into a 3D object. The present invention further provides a three-dimensional (3D) object as such, comprising at least one at least three-layer concrete-comprising segment which is able to be produced by the process of the invention.

The present invention relates to a three-dimensional (3D) printing process for the (layer-by-layer) production of at least one at least three-layer concrete-comprising segment (subregion) of a three-dimensional (3D) object based on concrete. In the process, a first concrete layer is firstly produced by extrusion of fresh concrete. Subsequently, a first adhesive layer is applied on top of the upward-facing side of the first concrete layer, after which a second concrete layer is applied to the upward-facing side of the first adhesive layer. Further adhesive and concrete layers can optionally be applied in succession, with the corresponding concrete layers and adhesive layers in the respective segment being arranged on top of one another in alternating order and the uppermost layer and the lowermost layer of the respective concrete-comprising segment being in each case formed by a concrete layer. The present invention further provides an at least three-layer concrete-comprising segment of a 3D object as such, which is produced by the process of the invention. The invention further provides for the use of at least one at least three-layer concrete-comprising segment as such for producing a 3D object or for incorporation into a 3D object. The present invention further provides a three-dimensional (3D) object as such, comprising at least one at least three-layer concrete-comprising segment which is able to be produced by the process of the invention.

3D Printing as such is now a widespread process in which, in principle, a suitable starting material is applied layer-by-layer (for example on a baseplate) and three-dimensional (3D) objects (also referred to as workpieces, articles or 3D printing product) can thus be produced in numerous variations in respect of geometry, shape, size and/or configuration. In the field of 3D printing, a number of different types/techniques of 3D printing processes are now known, for example selective laser melting, electron beam melting, selective laser sintering, stereolithography or the fused deposition modeling (FDM) process. The abovementioned processes as such are all known to a person skilled in the art and differ, in particular, in respect of the use of the specific starting materials and/or the specific process conditions by means of which the starting materials are transformed into the desired 3D product (for example use of specific lasers, electron beams or specific melting/extrusion techniques). The commercially available 3D printers are frequently matched to the desired 3D printing process.

3D Printing processes can also be used, inter alia, for producing very large objects or subregions (segments) of such large (3D) objects. It is thus now quite possible to produce even very large objects such as buildings/houses entirely or partially using 3D printing processes. In such cases, concrete-comprising materials are also used as starting materials in 3D printing processes. The great advantage of 3D printing processes in the production of large objects, for example buildings made of concrete-comprising materials, is that production of the corresponding objects or segments occurs layer by layer, which allows great variety in respect of the geometry, shape, size and/or configuration, while in the case of classical concrete production processes (or classical processes for producing objects composed of concrete), on the other hand, the corresponding object or subregion is produced in one piece, with molds for pouring in the concrete generally having to be used, which make shaping or further processing considerably more difficult.

Furthermore, it may be said that a 3D printing process is in principle an automated process in which the corresponding segment or the entire 3D object is produced largely or even completely mechanically on the basis of a predefined construction plan using a machine, i.e. the 3D printer, while in the case of classical methods many working steps are carried out manually (in the form of manual work). Classical concrete production processes are thus more time-consuming and costly and/or require a significantly large workforce.

If a 3D printing process is used in the production of concrete-comprising objects, this is in practice mostly effected by extrusion of concrete materials, with the appropriate concrete material being extruded or placed in position layer-by-layer via nozzles, for example for the erection of walls or other parts of buildings. A general problem here is that the concrete material used has to attain a high strength relatively quickly so that it can bear the weight of the further layers which are applied on top without spreading sidewards. Concrete materials which dry relatively quickly or develop a high strength relatively quickly are commercially available.

Despite these commercially available, quick-drying concrete materials, a substantial problem in the corresponding 3D printing processes is that the material used has been dried and/or cured to different degrees within a single layer since the horizontal application length of, for example, a wall or another desired segment can vary greatly and the drying process and/or curing process has thus progressed to a substantial extent in one part while in another part the surface is still wet enough to undergo bonding to the next concrete layer. Furthermore, each freshly applied concrete layer has a different average degree of drying or degree of curing than the corresponding underlying layer. The drier the individual layers, the more load can be borne by the respective layer, but the poorer is the adhesion at the interface between the individual layers. Accordingly, the connecting interfaces between the individual concrete layers in the 3D printing process can be regarded, in particular, as potential weak points of the correspondingly produced 3D objects because the stability is the lowest there.

U.S. Pat. No. B 7,814,937 discloses a method for the layer-by-layer production of large three-dimensional objects such as houses using cement-comprising materials. The cement-comprising material is processed layer-by-layer using a nozzle which is a constituent of a complex pressure apparatus to give a complex 3D object, in particular a house. Finally, U.S. Pat. No. B 7,814,937 discloses a three-dimensional printing process in which a 3D printer is installed in a fixed position on a vehicle, in particular a goods vehicle. Before the specific application, for example the production of a house, the 3D printer installed on the vehicle is brought to a ready-to-operate state, with the 3D printer having to be converted from the “folded-together state” (for transport on the vehicle) into a ready-to-operate state. Layer-by-layer application of the cement-comprising material ultimately produces (on the basis of the cement used) a presumably concrete-comprising, three-dimensional object, in particular a house. However, neither in this document nor in the two documents referred to below is there any indication as to how the adhesion problem between the individual 3D-printed layers can be overcome.

A further three-dimensional printing system which can be used for extruding cement-comprising material through a nozzle is disclosed in US-A 2010/0025349. The 3D printer described there is referred to as gantry robotics system. Movements of the nozzle in all directions in space (X, Y and Z direction) can be carried out as desired by means of an appropriately movable bridge to which an extrusion nozzle for the cement-comprising material is attached, as a result of which the cement-comprising material can be printed in any desired shapes.

US-A 2010/0257792 discloses an automated system for extrusion of construction material, including cement-comprising material. The automated system comprises an extrusion nozzle. Furthermore, extrusion nozzle systems which have at least two separately operable extrusion nozzles have been disclosed. Three-dimensional objects, for example, which have specific layers (walls) at the side faces of a correspondingly produced three-dimensional object can be produced by means of such systems using at least two extrusion nozzles.

EP-B 0 950 484 discloses a process and an apparatus for producing composite blocks. This process is not a 3D printing process but instead a classical process in which concrete is poured into a mold in order to cure there. Specifically, a process for producing composite blocks which in use positions comprise an upper natural stone plate and a lower support layer of concrete, which are intimately joined to one another, is described there. The natural stone plate with its upper side facing downward is placed on a substrate and tightly enclosed by a mold box using an elastic element surrounding the natural stone plate. Concrete is subsequently introduced into the mold box and compacted. The mold box is finally separated from the composite block. The composite block thus comprises a constituent composed of (cured) concrete and a constituent composed of a natural stone plate.

Regardless of whether a 3D printing process or a classical process for producing concrete-comprising 3D objects is to be used, a person skilled in the art will know that particular rules have to be adhered to in the processing of concrete-comprising materials and will know which specific chemical compounds/compositions are understood under the term “concrete” by a person skilled in the art (see, for example, the online encyclopedia Wikipedia under the term “Concrete”: https://en.wikipedia.org/wiki/concrete; version of Jan. 10, 2019). Previously cured concrete is referred to as solid concrete, but processing is carried out using fresh concrete, i.e. concrete which is not yet cured. Concrete is obtainable in various compositions, but cement (functions as binder), size fractions of stone (as aggregates) and water are generally comprised therein as basic constituents. In fresh concrete, the cement paste, i.e. a mixture of water, cement and further finely particulate constituents, is not yet set. As a result, the fresh concrete is still processable, i.e. shapable and sometimes flowable. In order to suppress settling of the concrete and possibly premature setting, fresh concrete is in practice generally kept in motion, for example in the form of mixers which can also be present on goods vehicles. Settling and (at least partial) curing of the corresponding fresh concrete mixture is suppressed thereby. As an alternative, chemical additives can also be added to the fresh concrete.

The problem addressed by the present invention is to provide a novel 3D printing process for producing three-dimensional objects or segments (subregions) thereof on the basis of concrete.

This problem is solved by a 3D printing process for the layer-by-layer production of an at least three-layer concrete-comprising segment of a three-dimensional (3D) object, comprising the following steps a) to c):
a) extrusion of fresh concrete to form a first concrete layer (B1) which comprises an upward-facing side,
b) application of a first adhesive layer (K1) to the first concrete layer (B1) using at least one adhesive, where the first adhesive layer (K1) completely or at least partly covers the upward-facing side of the first concrete layer (B1),
c) application of a second concrete layer (B2) by extrusion of fresh concrete on top of the first adhesive layer (K1), where the second concrete layer (B2) completely or at least partly covers the upward-facing side of the first adhesive layer (K1), to form an at least three-layer concrete-comprising segment of a 3D object, where the first concrete layer (B1) forms the lowermost layer, the first adhesive layer (K1) forms the intermediate layer and the second concrete layer (B2) forms the uppermost layer of the at least three-layer concrete-comprising segment.

Concrete-comprising segments having three or more layers of a three-dimensional (3D) object can be produced in an advantageous way by the process of the invention. These concrete-comprising segments have increased stability compared to conventionally produced layered segments since the layers are, according to the invention, joined adhesively to one another regardless of the degree of curing of the concrete used. Since the stability of such a concrete-comprising segment is greater, the stability of the corresponding three-dimensional object, for example a building, made up of one or more such multilayer concrete-comprising segments is also greater.

The corresponding at least three-layer or multilayer concrete-comprising segments can be produced more quickly and/or higher/larger by the process of the invention. In the same period of time, it is thus possible to build more quickly and higher/larger compared to classical concrete production processes and also known 3D printing techniques based on concrete. Owing to the adhesive layer present between the individual concrete-comprising layers, a plurality of superimposed layers can be applied more quickly or higher without having to wait for sufficient or complete curing of the layers underneath.

Due to the fact that an adhesive layer is used between the individual concrete layers in the 3D printing process of the invention, it is no longer necessary to wait until the concrete layer underneath has dried completely or at least substantially in order firstly to be able to rule out spreading of the concrete layer and at the same time achieve a very firm bond to the next concrete layer. For the purposes of the invention, the adhesive layer can preferably be applied on top of the concrete layer underneath as soon as the upward-facing side of the respective concrete layer has at least partly, preferably completely, cured as solid concrete. However, complete or at least substantial curing of the entire concrete layer located underneath is not necessary according to the invention.

While it is technically relatively simple to determine whether the surface of a concrete layer has cured, this does not apply to determination of the degree of curing of the complete concrete layer. In practice, the degree of curing of the entire concrete layer can generally not be determined accurately during a 3D printing process. Accordingly, it is in practice normal to wait in a 3D printing process for a relatively long time before the next concrete layer can be applied on top of an existing concrete layer in order to be able to definitely avoid spreading of an insufficiently cured lower concrete layer under the additional pressure of the freshly applied upper concrete layer. If the lower concrete layer partially spreads because of the additional weight, it thereby losses its shape which in turn has an adverse effect on the adhesion of the individual layers at the contact points. However, this adhesion is improved by the adhesive layer used according to the invention and thus also indirectly brings about pressure equilibration on the lower concrete layer which may not yet be completely cured. Consequently, it is particularly advantageous that, in the process of the invention, the adhesive layer can be applied to the concrete layer underneath at a time immediately before the 3D printing of the subsequent, superposed concrete layer. The adhesive layer can, for example, be applied through an additional nozzle or an additional printing head which is installed directly in front of the corresponding nozzle or the corresponding printing head for application of the next concrete layer. Thus, two operations can be carried out directly one after the other using a single 3D printing apparatus.

Compared to conventional concrete processing methods, the 3D printing process of the invention has the advantage that it is in principle an automated process, with the corresponding segment or the entire 3D object being produced largely or even completely mechanically generally on the basis of a predefined building plane using a machine, i.e. a 3D printer. In contrast thereto, a large part of the working steps is carried out manually in classical concrete production processes. This is much more time-consuming and costly; in particular, it requires a larger number of personnel. In addition, in contrast to conventional (classical) concrete production methods, no molds for pouring in the fresh concrete have to be used in the process of the invention.

Owing to the better adhesion of the individual layers to one another, the problem of the different state of drying of the respective layers is minimized or completely eliminated. The individual concrete-comprising layers and/or the multilayer concrete-comprising segment or the entire 3D object is/are thus more stable. For example, it displays no or fewer cracks, especially at the places at which the respective concrete-comprising layers are in contact. This can, for example, be determined by measurement of adhesive pull strengths. Adhesive pull strengths for two concrete layers which are applied on top of one another in a 3D printing process without an adhesive layer in between are generally in the range from 0 to 0.1 N/mm². In contrast thereto, the corresponding tensile pull strengths after the process of the invention with an adhesive layer in between are from 0.5 to 3 N/mm², which amounts to a significantly improved adhesion/stability. Adhesive pull strengths can, for example, be determined in accordance with the standard DIN 1048 (1979-06-13).

The stability of the multilayer concrete-comprising segments produced using the process of the invention is thus comparable to the stability of a corresponding concrete fragment which has been produced by a classical single-stage process using appropriate molds for defining the geometry (as are described, for example, in EP-B 0 950 484). However, compared to such classical methods for processing concrete-comprising objects, the layer-by-layer production process of the invention has the advantage of a significantly greater variation in respect of geometry, shape, size and configuration of the corresponding concrete-comprising object.

For the purposes of the present invention, all directions indicated, for example X direction, Y direction or Z direction and XY planes, relate (unless indicated otherwise) to a cartesian coordinate system in three-dimensional space. This means that the three directional axes (X axis, Y axis and Z axis) are each orthogonal to one another, i.e. in each case form an angle of 90° to one another. The Z axis (Z direction) is also referred to as “vertical axis”. XY planes can also be referred to as horizontal planes, with a plurality of XY planes being able to be arranged parallel to one another in the vertical direction (i.e. along the Z axis). Movements along the Z axis can also be referred to as “upward” or “downward”.

The present invention will be defined in more detail below.

The present invention firstly provides a 3D printing process for the layer-by-layer production of an at least three-layer concrete-comprising segment of a three-dimensional (3D) object, comprising the following steps a) to c):
a) extrusion of fresh concrete to form a first concrete layer (B1) which comprises an upward-facing side,
b) application of a first adhesive layer (K1) to the first concrete layer (B1) using at least one adhesive, where the first adhesive layer (K1) completely or at least partly covers the upward-facing side of the first concrete layer (B1),
c) application of a second concrete layer (B2) by extrusion of fresh concrete on top of the first adhesive layer (K1), where the second concrete layer (B2) completely or at least partly covers the upward-facing side of the first adhesive layer (K1), to form an at least three-layer concrete-comprising segment of a 3D object, where the first concrete layer (B1) forms the lowermost layer, the first adhesive layer (K1) forms the intermediate layer and the second concrete layer (B2) forms the uppermost layer of the at least three-layer concrete-comprising segment.

For the purposes of the present invention, the term “concrete” has the following meaning: Concrete is a mixture comprising cement, size fractions of stone and also water as main components. Depending on the desired application, further additives can also be comprised in the concrete. The absolutely necessary constituent cement serves as binder. The expression “size fraction of stone” encompasses, for the purposes of the invention, components such as crushed rock, gravel or optionally also sand. The size fraction of stone is also referred to as aggregate of the concrete. The water comprised in the concrete is also referred to as added water/makeup water and serves for setting of the concrete.

According to the invention, the concrete preferably comprises a proportion of binder, preferably a proportion of cement, in the range of not more than 25% by weight, more preferably not more than 20% by weight and particularly preferably in the range from 10 to 15% by weight. The minimum proportion of binder, preferably of cement, in the concrete is generally at least 1% by weight, preferably at least 5% by weight.

As cement, it is possible to use, according to the invention, any cement known to a person skilled in the art. Cements can be used here in pure form, but cements are frequently also admixed with further additives which may likewise function as binder, for example fly ashes, slags or pozzolans (see also the standard DIN EN196). According to the invention, preference is also given to the concrete comprising a total proportional binder of from 240 to 320 kg/m³.

An analogous situation also applies to the term “concrete-comprising” or the term “concrete layer”. Preference is given according to the invention to a concrete or a concrete layer which cures quickly and/or has a high dimensional stability.

Unless indicated otherwise in the context of the present invention, the term “concrete” preferably refers to already (at least partially) cured, in particular completely cured, concrete, which can also be referred to as “solid concrete”. In the case of solid concrete, the setting process initiated by water, i.e. the chemical bonding of water with the binder cement and/or the size fraction of stone, is thus completely or at least largely concluded.

For the purposes of the present invention, the term “fresh concrete” means that the corresponding concrete is still processable. The individual basic components of the concrete, in particular the binder and the water, have not yet reacted with one another, or at least reacted with one another to only a small extent, so that curing has not yet taken place. Fresh concrete is thus still shapable and at least partially flowable.

According to the invention, the term “concrete-comprising segment” has the following meaning: A concrete-comprising segment is made up of a number of (a plurality of) concrete layers and adhesive layers, with the concrete layers and adhesive layers being arranged above one another in an alternating sequence. The uppermost layer (upper side) and the bottommost layer (underside) of the respective concrete-comprising segment are each formed by a concrete layer. In the concrete-comprising segment, the concrete is generally, in particular after completion of the production process, already completely cured. Concrete-comprising segments as such can in themselves likewise be a three-dimensional object. In general, however, a plurality of such concrete-comprising segments are assembled to form a three-dimensional object or a three-dimensional object comprises at least one such concrete-comprising segment.

According to the invention, the concrete-comprising segments can be made up of any number of individual concrete layers. According to the invention, the “smallest concrete-comprising segment” (smallest unit) is a three-layer concrete-comprising segment. A three-layer concrete-comprising segment is obtained, according to the invention, when the process steps a) to c) are each carried out once. A three-layer concrete-comprising segment thus has a first concrete layer (B1) as lowermost layer (underside), a first adhesive layer (K1) as intermediate layer and a second concrete layer (B2) as uppermost layer (upper side).

According to the invention, concrete-comprising segments can, however, also be produced with a (much) larger number of layers than the above-described (at least) three-layer concrete-comprising segment of a three-dimensional (3D) object. To produce such concrete-comprising segments having a larger number of layers or many layers, the above-described steps b) and c) are, according to the invention, repeated at least once (step d) according to the invention).

The respective concrete layers can have different or identical geometries, thicknesses and/or chemical compositions in respect of the fresh concrete used for production. However, preference is given according to the invention to the individual concrete layers comprised in a concrete-comprising segment to be identical or at least largely identical in respect of their chemical composition, their shape, geometry and/or size.

An analogous situation also applies to the adhesive layers and/or the ratio of adhesive layers to concrete layers, with adhesive layers and concrete layers preferably differing from one another in respect of their thickness (extension in the Z direction).

For the purposes of the present invention, the term “three-dimensional (3D) object” or “3D objects comprising at least one at least three-layer concrete-comprising segment (according to the invention)” means that the corresponding 3D object can also be composed of two or more concrete-comprising segments according to the invention. In addition, the 3D object can also comprise subregions/components which differ from a concrete-comprising segment of the present invention. If the 3D object according to the invention is, for example, a building, parts (regions/segments) of the corresponding 3D object can have been produced by the process of the invention. An example is the walls of a house. Other parts of such a 3D object can have been produced by another process and/or they can have been produced from another material. Such parts can, for example, be doors, windows and/or roofs of a house.

Methods for joining/assembling two or more at least three-layer concrete-comprising segments according to the invention to/with one another and/or to/with other components so as to give a 3D object or parts thereof are known to a person skilled in the art. This can be effected by, for example, screwing together or adhesive bonding. According to the invention, it is theoretical also conceivable for a three-dimensional (3D) object such as a building to be made layer-by-layer of a single multilayer concrete-comprising segment according to the invention.

In order to produce concrete-comprising segments according to the invention which have more than three layers, i.e. to produce many-layer (multilayer or having a large number of layers) concrete-comprising segments, the optional process step d) which is defined as follows is carried out according to the invention:
d) at least single repetition of the steps b) and c) to form a many-layer concrete-comprising segment of a 3D object, where the respective concrete layers and adhesive layers are arranged above one another in an alternating sequence in the many-layer concrete-comprising segment and the uppermost layer and the bottommost layer of the concrete-comprising segment are each formed by a concrete layer.

According to the invention, the optional process step d) can be carried out as often as desired. Each time the process step d) is carried out, the step b) according to the invention and the step c) according to the invention are thus each repeated once. According to the invention, the optional process step d) is preferably carried out at least once. In this way, it is possible to produce many-layer concrete-comprising segments of a three-dimensional (3D) object.

If, for example, a concrete-comprising segment is to be made according to the invention of four concrete layers, a first concrete layer (B1) is, according to the invention, firstly produced by extrusion of the appropriate fresh concrete (step a)). A first adhesive layer (K1) is subsequently applied on top of the first concrete layer (B1) as per step b). A second concrete layer (B2) is subsequently applied by extrusion of fresh concrete on top of the first adhesive layer (K1) in step c).

The fresh concrete of the second concrete layer (B2) can have the same chemical composition as the fresh concrete which has been used for producing the first concrete layer (B1). The two concrete layers (B1) and (B2) can optionally also differ in respect of the chemical composition of the corresponding fresh concrete or the geometrical shape and/or layer thickness. The respective concrete layers (B1) and (B2) and also any further concrete layers preferably match in respect of the fresh concrete used and the geometry, shape and layer thickness.

The optional inventive step d) is subsequently carried out twice; thus, the abovementioned process steps b) and c) are repeated twice until a concrete-comprising segment having a total of four concrete layers has been produced. This many-layer concrete-comprising segment thus comprises a total of four concrete layers (B1, B2, B3 and B4), with the first concrete layer (B1) and the fourth concrete layer (B4) forming the bottommost layer or underside (B1) and the uppermost layer or upper side (B4), respectively, of the corresponding concrete segment. Thus, three adhesive layers (K1 to K3) are present between the total of four concrete layers (B1 to B4). In the abovementioned example, a seven-layer concrete-comprising segment comprising four concrete layers (B1 to B4) and three adhesive layers (K1 to K3) in an alternating sequence has thus been produced.

For the purposes of the present invention, the term “many-layer concrete-comprising segment” thus always refers to the sum of the alternating concrete layers and adhesive layers. In this context, many-layer is thus always an odd number of layers because each concrete-comprising segment always has a concrete layer as uppermost layer and bottommost layer. Many-layer concrete-comprising segments can thus be, for example, five-layer, seven-layer, nine-layer, fifty-one-layer concrete-comprising segments or concrete-comprising segments having an even larger number of layers.

An alternative way of counting can, according to the invention, be carried out so that only the number of concrete layers in the respective multilayer concrete-comprising segment are counted. It will be clear to a person skilled in the art that regardless of the way of counting, it is thus possible to produce, according to the invention, many-layer concrete-comprising segments having any desired number of concrete layers. For example, concrete-comprising segments having 5, 10, 100 or even more concrete layers can also be produced in this way. A concrete-comprising segment having 100 concrete layers thus comprises one hundred concrete layers (B1 to B100) having 99 adhesive layers (K1 to K99) located in between. A concrete-comprising segment having 100 concrete layers is, according to the above-described first way of counting according to the invention, thus a 199-layer concrete-comprising segment.

The respective thicknesses (Z direction) of the individual layers of a concrete-comprising segment can assume any dimensions. The respective concrete layers within a three- or many-layer concrete-comprising segment preferably have (largely) the same layer thickness. An analogous situation also applies to the adhesive layers which are present in each case. Furthermore, preference is given to at least one concrete layer, preferably all concrete layers, having a greater thickness than at least one adhesive layer, preferably all adhesive layers. Even greater preference is given to the ratio of the average thickness of a concrete layer to the average thickness of an adhesive layer applied thereto being >1:1, preferably >3:1, in particular 6:1 to 50:1. According to the invention, preference is given to an adhesive layer having a thickness of from 0.2 to 10 mm and/or a concrete layer having a thickness of from 10 to 300 mm. More preferably, a bonding layer has a thickness of from 1 to 5 mm and a concrete layer has a thickness of from 10 to 100 mm.

In the steps b), c) and/or optionally d) according to the invention, the in each case subsequent layer (either an adhesive layer or a concrete layer) is in each case applied so that the upward-facing side of the layer located underneath is completely or at least partly covered (in the X and/or Y direction). According to the invention, the layer to be applied in each case is preferably applied completely or virtually completely over the layer located underneath. If a corresponding subsequent layer is to be applied to only part of the layer underneath, preference is given according to the invention to at least 50%, even more preferably at least 75%, in particular at least 90%, of the total area of the upward-facing side of the layer underneath being covered by the corresponding subsequent layer. The incomplete coverage of an underlying layer by a subsequent layer to be applied thereto can, inter alia, be carried out when, for example, openings such as windows or doors are to be incorporated into or taken into account in the corresponding at least three-layer concrete-comprising segment. This can also apply analogously if a different geometry, shape, length (X direction) and/or width (Y direction) compared to the underlying concrete layer or adhesive layer is to be realized in the subsequent concrete layer.

The extrusion of fresh concrete as such, as is carried out in process steps a), c) and optionally d) according to the invention, is known to a person skilled in the art. According to the invention, this is carried out in the framework of a 3D printing process using a suitable 3D printer. 3D Printing processors as such and/or 3D printers as such using concrete-comprising substances are known to a person skilled in the art and are disclosed, for example, in the above-described prior art U.S. Pat. No. B 7,814,937, US-A 2010/0025349 or US A 2010/0257792.

The application of the first adhesive layer (K1) in step b) according to the invention and optionally the repetition thereof in the optional step d) does not necessarily have to be carried out by extrusion of the adhesive in question. However, carrying out process step b) by extrusion of the at least one adhesive used is preferred according to the invention. This also applies analogously to any repetition of step b) in an optional process step d). If the respective adhesive layers are not applied by extrusion to the concrete layer located underneath in each case, this can, according to the invention, be carried out by all methods known to a person skilled in the art, for example by brushing on, spraying on or other methods of application. Application of the adhesive layer, for the purposes of the invention, generally be carried out manually or automatically and is preferably carried out automatically.

As adhesives, it is possible, according to the invention, to use any compound known to a person skilled in the art, in particular compounds which make a stable bond between the cured concrete and fresh concrete possible and/or which can be extruded in an at least partially liquid state. Preference is given to using concrete slurries as adhesive. For the purposes of the present invention, the term “concrete slurry” refers to a type of concrete which is more liquid than conventional (quick-curing) concrete or fresh concrete. Concrete slurry preferably comprises two thirds cement and one third sand to which from 15 to 40% by weight of water is in turn added.

Concrete slurries can also be referred to as bonding slurries. Concrete slurries can comprise not only a higher proportion of binder compared to conventional concrete, in particular a higher proportion of cement, but also further components such as size fractions of stone, in particular crushed rock, gravel or sand. Likewise, water and/or other additives can be comprised in concrete slurries. As other additives, concrete slurries preferably comprise, according to the invention, plasticizers (e.g. polycarboxylate ethers), celluloses, in particular methyl celluloses, latex dispersions or dispersion powders. Latex dispersions or dispersion powders are preferably based on styrene-acrylate, vinyl acetate-ethylene, vinyl acetate or styrene-butadiene. In addition, further additives such as wetting agents or thickeners can be added in order to improve incorporation into the concrete slurries according to the invention. Celluloses are also used as water retention agents.

Preference is also given according to the invention to concrete slurries comprising at least 30% by weight of binder, preferably cement, even more preferably from 50 to 70% by weight of binder, in particular cement. The content of water in the concrete slurries is preferably from 15 to 40% by weight, with the water optionally being able to be replaced entirely or at least partly by liquefiers or plasticizers.

According to the invention, preference is thus given to the at least one adhesive being applied by extrusion to the concrete layer underneath in steps b) and/or optionally d).

Furthermore, the 3D printing process is preferably carried out as 3D extrusion printing process, in particular with all process steps a) to d) being carried out as 3D extrusion printing processes.

Furthermore, preference is given according to the invention to the 3D printing process being carried out with computer assistance, in particular using at least one slicer software. Computer-aided methods for carrying out a 3D printing process and/or suitable slicer software are known per se to a person skilled in the art.

Furthermore, the extrusion of fresh concrete in steps a) c) and/or optionally d) is, according to the invention, preferably carried out using a first nozzle (D1); the nozzle (D1) is preferably a constituent of a 3D printer and the nozzle (D1) is in particular comprised in a printing head of a 3D printer.

Furthermore, the extrusion of the adhesive is, according to the invention, preferably carried out using a second nozzle (D2); the nozzle (D2) is preferably a constituent of a 3D printer and the nozzle (D2) is in particular comprised in a printing head of a 3D printer.

Preference is likewise given for the purposes of the invention to the nozzles (D1) and (D2) being constituents of the same 3D printer, where
i) the two nozzles (D1) and (D2) are preferably arranged in the same printing head of the 3D printer and are operated in a coupled manner, or
ii) the two nozzles (D1) and (D2) are preferably arranged in separate printing heads of the 3D printer and are operated separately from one another.

In a preferred embodiment of the process of the invention, the adhesive is applied to the concrete layer underneath in steps b) and/or optionally d) only when the upward-facing side of the respective concrete layer has cured at least partially, preferably completely, as solid concrete.

Furthermore, the application of the next concrete layer on top of the upward-facing side of the respective adhesive layer in step c) and/or optionally d) is, according to the invention, preferably carried out by
i) the next concrete layer being applied immediately after complete formation of the adhesive layer on the concrete layer underneath, or
ii) the next concrete layer being applied simultaneously with the adhesive to the concrete layer underneath, with the fresh concrete being extruded to form the next concrete layer only at those places at which adhesive has been applied to the concrete layer underneath to form a corresponding subregion of the adhesive layer.

Particular preference is given to the next concrete layer being applied simultaneously with the adhesive to the concrete layer underneath, with the fresh concrete to form the next concrete layer being extruded only onto those places at which adhesive has been applied on top of the concrete layer underneath to form a corresponding subregion of the adhesive layer.

According to the invention, the 3D object is preferably a building or part of a building, and the building is preferably a house, a dwelling, a hall, a garage and/or a store. A part of a building is for the present purposes preferably a masonry wall, a wall, a balcony, a roof, a floor and/or a shell construction. A building or part of a building can also be provided with or joined to other objects which have not been produced by a 3D printing process, for example doors, windows, roof gutters and other comparable fittings.

Furthermore, preference is given according to the invention to all at least three-layer concrete-comprising segments or at least a major part of the at least three-layer concrete-comprising segments, preferably all at least three-layer concrete-comprising segments, in the respective 3D object having been produced by a process involving steps a) to c) and optionally d).

The present invention further provides an at least three-layer concrete-comprising segment of a 3D object which is able to be produced by the above-described process.

The 3D object is preferably a building or part of a building, and the building is preferably a house, a dwelling, a hall, a garage and/or a store.

The present invention thus further provides for the use of at least one at least three-layer concrete-comprising segment according to the present invention for producing a 3D object or for incorporation into a 3D object, with the 3D object preferably being a building or part of a building and the building preferably being a house, a dwelling, a hall, a garage and/or a store.

The present invention further provides a three-dimensional (3D) object comprising at least one at least three-layer concrete-comprising segment according to the present invention.

1-13. (canceled)

14. A three-dimensional (3D) printing process for the layer-by-layer production of an at least three-layer concrete-comprising segment of a three-dimensional (3D) object, comprising the following steps a) to c):
a) extrusion of fresh concrete to form a first concrete layer (B1) which comprises an upward-facing side,
b) application of a first adhesive layer (K1) to the first concrete layer (B1) using at least one adhesive, where the first adhesive layer (K1) completely or at least partly covers the upward-facing side of the first concrete layer (B1), where the at least one adhesive is applied by extrusion to the concrete layer underneath,
c) application of a second concrete layer (B2) by extrusion of fresh concrete on top of the first adhesive layer (K1), where the second concrete layer (B2) completely or at least partly covers the upward-facing side of the first adhesive layer (K1), to form an at least three-layer concrete-comprising segment of a 3D object, where the first concrete layer (B1) forms the lowermost layer, the first adhesive layer (K1) forms the intermediate layer and the second concrete layer (B2) forms the uppermost layer of the at least three-layer concrete-comprising segment, where the extrusion of fresh concrete in steps a) and c) is carried out using a first nozzle (D1) and the extrusion of the adhesive is carried out using a second nozzle (D2), where the nozzles (D1) and (D2) are constituents of the same 3D printer, where the two nozzles (D1) and (D2) are arranged in separate printing heads of the 3D printer and are operated separately from one another.

15. The 3D printing process according to claim 14, wherein the process comprises an additional step d), where
d) at least single repetition of the steps b) and c) to form a many-layer concrete-comprising segment of a 3D object, where the respective concrete layers and adhesive layers are arranged above one another in an alternating sequence in the many-layer concrete-comprising segment and the uppermost layer and the bottommost layer of the concrete-comprising segment are each formed by a concrete layer.

16. The 3D printing process according to claim 14, wherein
i) the process is carried out as a 3D extrusion printing process, and/or
ii) the process is carried out with computer assistance, in particular using at least one slicer software.

17. The 3D printing process according to claim 14, wherein the at least one adhesive is applied by extrusion to the concrete layer underneath in step d).

18. The 3D printing process according to claim 14, wherein concrete slurries are used as adhesive.

19. The 3D printing process according to claim 14, wherein the adhesive is applied to the concrete layer underneath in steps b) and/or optionally d) only when the upward-facing side of the respective concrete layer has cured at least partially as solid concrete.

20. The 3D printing process according to claim 15, wherein the application of the next concrete layer on top of the upward-facing side of the respective adhesive layer in step c) and/or optionally d) is carried out by
i) the next concrete layer being applied immediately after complete formation of the adhesive layer on the concrete layer underneath, or
ii) the next concrete layer being applied simultaneously with the adhesive to the concrete layer underneath, with the fresh concrete being extruded to form the next concrete layer only at those places at which adhesive has been applied to the concrete layer underneath to form a corresponding subregion of the adhesive layer.

21. The 3D printing process according to claim 14, wherein the 3D object is a building or part of a building.

22. The 3D printing process according to claim 15, wherein all at least three-layer concrete-comprising segments or at least a major part of the at least three-layer concrete-comprising segments in the respective 3D object have been produced by a process involving the steps a) to c) and optionally d).

23. The 3D printing process according to claim 14, wherein the ratio of the average thickness of a concrete layer to the average thickness of an adhesive layer applied thereto is >1:1.

24. An at least three-layer concrete-comprising segment of a 3D object which is produced by the process according to claim 14.

25. The use of at least one at least three-layer concrete-comprising segment according to claim 24 for producing a 3D object or for incorporation into a 3D object.

26. A three-dimensional (3D) object comprising at least one at least three-layer concrete-comprising segment according to claim 24.

27. The 3D printing process according to claim 14, wherein the adhesive is applied to the concrete layer underneath in steps b) and/or optionally d) only when the upward-facing side of the respective concrete layer has cured completely, as solid concrete.

28. The 3D printing process according to claim 14, wherein the application of the next concrete layer on top of the upward-facing side of the respective adhesive layer in step c) and/or optionally d) is carried out by
iii) the next concrete layer being applied immediately after complete formation of the adhesive layer on the concrete layer underneath, or
iv) the next concrete layer being applied simultaneously with the adhesive to the concrete layer underneath, with the fresh concrete being extruded to form the next concrete layer only at those places at which adhesive has been applied to the concrete layer underneath to form a corresponding subregion of the adhesive layer, with the next concrete layer being applied simultaneously with the adhesive on top of the concrete layer underneath, with the fresh concrete to form the next concrete layer being extruded only onto those places at which adhesive has been applied on top of the concrete layer underneath to form a corresponding subregion of the adhesive layer.

29. The 3D printing process according to claim 14, wherein the 3D object is a a house, a dwelling, a hall, a garage and/or a store.

30. The 3D printing process according to claim 14, wherein all at least three-layer concrete-comprising segments in the respective 3D object have been produced by a process involving the steps a) to c) and optionally d).

31. The 3D printing process according to claim 14, wherein the ratio of the average thickness of a concrete layer to the average thickness of an adhesive layer applied thereto is >3:1.

32. The 3D printing process according to claim 14, wherein the ratio of the average thickness of a concrete layer to the average thickness of an adhesive layer applied thereto is 6:1 to 50: 1.

33. An at least three-layer concrete-comprising segment of a 3D object which is produced by the process according to claim 14, with the 3D object being a building or part of a building and the building preferably being a house, a dwelling, a hall, a garage and/or a store.
